(19) United States
(12) Patent Application Publication
(10) Pub. No.: US 2011/0055104 A1
(43) Pub. Date: Mar. 3, 2011

(54) SYSTEMS AND METHODS FOR DETECTING UNFAIR MANIPULATIONS OF ON-LINE REPUTATION SYSTEMS

(75) Inventors: Yan Sun, Wakefield, RI (US); Steven M. Kay, Middletown, RI (US); Yafei Yang, Escondido, CA (US); Qing Yang, Saunderstown, RI (US)

(73) Assignee: The Board of Governors for Higher Education, State of Rhode Island and Providence Plantations, Providence, RI (US)

(21) Appl. No.: 12/909,062

(22) Filed: Oct. 21, 2010

Related U.S. Application Data
(63) Continuation of application No. PCT/US2009/043957, filed on May 14, 2009.
(60) Provisional application No. 61/053,195, filed on May 14, 2008.

(51) Int. Cl. G06Q 30/00

(52) U.S. Cl. 705/347

(57) ABSTRACT

A method is disclosed for detecting unfair ratings in rating data over a period of time in connection with an on-line rating system. The method includes the steps of: detecting changes in an arrival rate of ratings in the rating data over the period of time and providing arrival rate change data; detecting changes in a model of the rating data over the period of time such that changes in the model are represented as model errors and providing model error data; detecting changes in a histogram of the rating data over the period of time and providing histogram detection data; detecting changes in a mean of the rating data over the period of time and providing mean change detection data; and processing the arrival rate change data, the model error data, the histogram detection data, and the mean change detection data to identify unfair ratings in the rating data.

### PRIORITY

The present application claims priority to U.S. Provisional Patent Application Ser. No. 61/053,195 filed May 14, 2008, the entire disclosure of which is hereby incorporated by reference.

### BACKGROUND

The present application generally relates to the monitoring of on-line rating systems, and relates in particular to systems and methods for detecting unfair tampering with on-line rating systems.

The use of on-line rating systems continues to grow not just as use of the Internet expands, but also with users' growing desire to vet the reputation of products and services that they may wish to purchase. Such online reputation systems, also known as the online feedback-based rating systems, are creating large scale, virtual word-of-mouth networks in which individuals share opinions and experiences by providing ratings to products, companies, digital content and even other people. For example, the website Epinions.com encourages Internet users to rate virtually any type of businesses. The website Citysearch.com solicits and displays user ratings on restaurants, bars, and performances. The website YouTube.com recommends video clips based on viewers' ratings.

The value of reputation systems has been well proved by research as well as the success of reputation-centric online businesses. See “How valuable is a good reputation? A sample selection model of internet auctions” by J. Livingston, The Review of Electronics and Statistics, vol. 87, no. 3, pp. 453-465 (August 2005). Another study showed that eBay sellers with established reputation could expect about 8% more revenue than new sellers marketing the same goods. See “The value of reputation on ebay: A controlled experiment” by P. Resnick, R. Zeckhauser, J. Swanson, and K. Lockwood, Experimental Economics, vol. 9, no. 2, pp. 79-101 (June 2006). Further, a recent survey conducted by comScore Inc. and the Kelsey Group revealed that consumers were willing to pay at least 20% more for services receiving an Excellent or 5-star rating than for the same service receiving a Good or 4-star rating. See “Online consumer-generated reviews have significant impact on online purchase behavior” at http://www.comscore.com/press/release.asp?press=1928 (November 2007). The website Digg.com was built upon a feedback-based reputation system that rates news and articles based on user feedback. After only 3 years of operation, this company now has a price tag of 300 million dollars and has overtaken Facebook.com in terms of the number of unique visitors. See “Digg overtakes facebook; both cross 20 million U.S. unique visitors” by J. Meattle, compete.com (2007).

As reputation systems are having increasing influence on purchasing decision of consumers and online digital content distribution, the manipulation of such systems is also rapidly growing. Firms post biased ratings and reviews to praise their own products or bad-mouth the products of their competitors. Political campaigns promote positive video clips and hide negative video clips by inserting unfair ratings at YouTube.com. There is ample evidence that such manipulation takes place. See “Strategic manipulation of internet opinion forums: Implications for consumers and firms” by C. Dellarocas, Management Science (October 2006). In February 2004, due to a software error, Amazon.com's Canadian site mistakenly revealed the true identities of some book reviewers. It turned out that a sizable proportion of those reviews/ratings were written by the books' own publishers, authors, and competitors. See “Amazon glitch unmasks war of reviewers” by A. Harmon, The New York Times (Feb. 14, 2004). The scammers are creating sophisticated programs that mimic legitimate YouTube.com traffic and provide automated ratings for videos they wish to promote. See “Scammers gaming youtube ratings for profit” by M. Hines, InfoWorld, http://www.infoworld.com/article/07/05/16/cybercrooks gaming google 1.html, (May 2007). Some eBay.com users are artificially boosting their reputation by buying and selling feedbacks. See “Reputation in online auctions: The market for trust” by J. Brown and J. Morgan, California Management Review, vol. 49, no. 1, pp. 61-81 (2006). The online reputation systems are facing a major challenge: how to deal with unfair ratings from dishonest, collaborative, and even profit-driven raters.

A common detection scheme for detecting unfair ratings is based on the majority rule. That is, mark the ratings that are far away from the majority's opinion as unfair ratings. The majority rule holds under two conditions. First, the number of unfair ratings is less than the number of honest ratings. Second, the bias of the unfair ratings (i.e., the difference between the unfair ratings and the honest ratings) is sufficiently large. The number of ratings, however, for one product may be small. For example, the majority of products at Amazon.com are reported to have less than 50 ratings. It is not difficult for the manipulator (also referred to as the attacker) to register/control a large number of user IDs that make the unfair ratings overwhelm the honest ratings. Furthermore, the attacker may introduce a relatively small bias in unfair ratings. The smart attackers therefore, may defeat the majority-rule based detection methods by either introducing a large number of unfair ratings or introducing unfair ratings with relatively small bias.

Another conventional detection scheme involves examining clustering in order to try to separate unfair ratings from honest ratings. See “Immunizing online reputation reporting systems against unfair ratings and discriminatory behavior” by C. Dellarocas, Proceedings of the 2nd ACM conference on Electronic commerce, pp. 225-232 (2000). A further detection scheme involves having each rater give high endorsements to other raters who provide similar ratings and low endorsements to the raters that provide different ratings. The quality of a rating, which is the summation of the endorsements from all other raters, is used to separate unfair and honest ratings. See “Computing and using reputations for internet ratings” by M. Chen and J. Singh, Proceedings of the 3rd ACM conference on Electronic Commerce (2001).

In “Filtering out unfair ratings in Bayesian reputation systems” by A. Whitby, A. Jøsang, and J. Indulska, Proc. 7th Int. Workshop on Trust in Agent Societies (2004) a statistical filtering technique is presented that is based on Beta-function analyses. The ratings that are outside the q quantile and (1−q) quantile of the majority opinion are identified as unfair ratings, where q is a parameter describing the sensitivity of the algorithm. In “An entropy-based approach to protecting rating systems from unfair testimonies” by J. Weng, C. Miao, and A. Goh, IEICE TRANSACTIONS on Information and Systems, vol. E89-D, no. 9, pp. 2502-2511 (September 2006), it is disclosed that if a new rating leads to a significant change in the uncertainty in rating distribution, it is considered to be an unfair rating. These schemes work well when the majority rule holds, but the effectiveness degrades significantly when the majority rule does not hold.

Trust establishment has been employed for authorization and access control, electronics commerce, peer-to-peer networks, distributed computing, ad hoc and sensor networks, and pervasive computing. See “The eigentrust algorithm for reputation management in p2p networks” by S. Kamvar, M. Schlosser, and H. Garcia-Molina, Proceedings of 12th International World Wide Web Conferences (May 2003); “A survey of trust and reputation systems for online service provision” by A. Jøsang, R. Ismail, and C. Boyd, Decision Support Systems, vol. 43, no. 2, pp. 618-644 (2005); “Powertrust: A robust and scalable reputation system for trusted peer-to-peer computing” by R. Zhou and K. Hwang, IEEE Transactions on Parallel and Distributed Systems, vol. 18, no. 5 (May 2007); and “Reputation-based framework for high integrity sensor networks” by S. Ganeriwal and M. Srivastava, Proceedings of ACM Security for Ad-hoc and Sensor Networks (SASN), Washington, D.C. (October 2004).

For rating aggregation problems simple trust models are used to calculated trust in raters in “Computing and using reputations for interne ratings” by M. Chen and J. Singh, Proceedings of the 3rd ACM conference on Electronic Commerce (2001); “Peertrust: Supporting reputation-based trust for peer-to-peer electronic communities” by L. Xiong and L. Liu, IEEE Transactions on Knowledge and Data Engineering, vol. 16, no. 7, pp. 843-857 (July 2004); and “Reputation rating system based on past behavior of evaluators” by K. Fujimura and T. Nishihara, Proceedings of the 4th ACM conference on Electronic commerce (2003). The effectiveness of such techniques however, is generally restricted due to limitations of the underlying detection algorithms.

There is a need therefore, for an improved system and method for detecting unfair and malicious ratings in on-line ratings systems. This problem is particularly challenging when the number of honest ratings is relatively small and unfair ratings may contribute to a significant portion of the overall ratings. In addition, the lack of unfair rating data from real human users is another obstacle toward realistic evaluation of defense mechanisms.

### SUMMARY

The invention provides a method for detecting unfair ratings in rating data over a period of time in connection with an on-line rating system. In accordance with an embodiment, the method includes the steps of: detecting changes in an arrival rate of ratings in the rating data over the period of time and providing arrival rate change data; detecting changes in a model of the rating data over the period of time such that changes in the model are represented as model errors and providing model error data; detecting changes in a histogram of the rating data over the period of time and providing histogram detection data; detecting changes in a mean of the rating data over the period of time and providing mean change detection data; and processing the arrival rate change data, the model error data, the histogram detection data, and the mean change detection data to identify unfair ratings in the rating data.

In accordance with another embodiment, the method includes the steps of: detecting changes in a model of the rating data over the period of time such that changes in the model are represented as model errors and providing model error data; detecting changes in a histogram of the rating data over the period of time and providing histogram detection data; detecting changes in a mean of the rating data over the period of time and providing mean change detection data; providing the detection results based on the model error data, the histogram detection data and the mean change data to a trust management system, which provides trust values for each of a plurality of raters; and processing the trust values for each of a plurality of raters to identify unfair ratings in the rating data

In accordance with a further embodiment, the invention provides a system for detecting unfair ratings in rating data over a period of time for in connection with an on-line rating system. The system includes an arrival rate change detection unit, a model change detection unit, a histogram detection unit, a mean change detection unit, a trust manager system, and a filter unit. The arrival rate change detection unit detects changes in an arrival rate of ratings in the rating data over the period of time and provides arrival rate change data. The model change detection unit detects changes in a model of the rating data over the period of time such that changes in the model are represented as model errors and provides model error data. The histogram detection unit detects changes in a histogram of the rating data over the period of time and provides histogram detection data. The mean change detection unit detects changes in a mean of the rating data over the period of time and provides mean change detection data. The trust manager system receives the arrival rate change data, the model error data, the histogram detection data, and the mean change detection data, and provides trust values for each of a plurality of raters. The filter means for removes unfair ratings based on the trust values.

### BRIEF DESCRIPTION OF THE ILLUSTRATED EMBODIMENTS

The following description may be further understood with reference to the accompanying drawings in which:

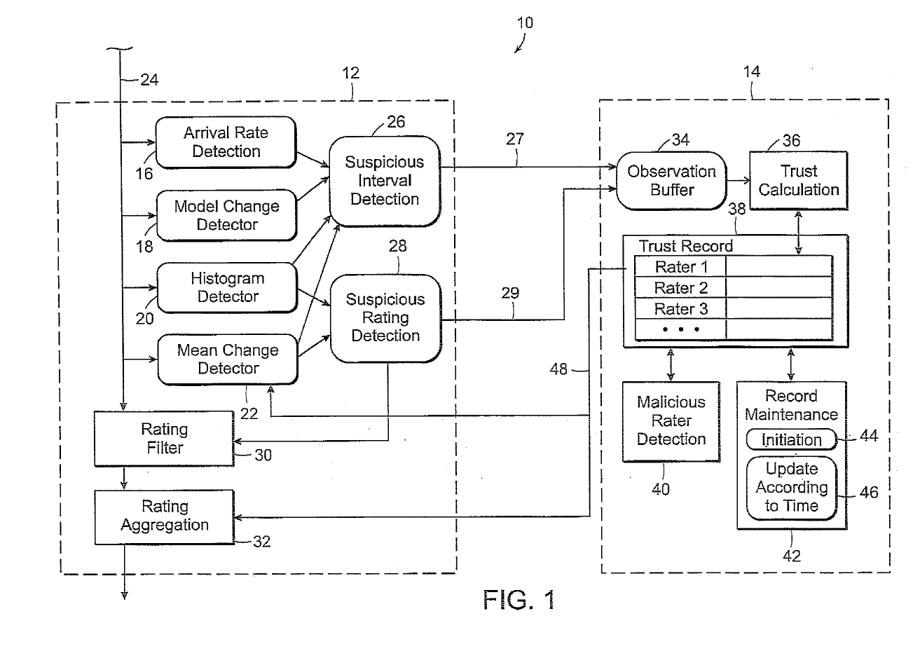

FIG. 1 shows an illustrative diagrammatic view of a trust-enhanced rating aggregation system in accordance with an embodiment of the invention;

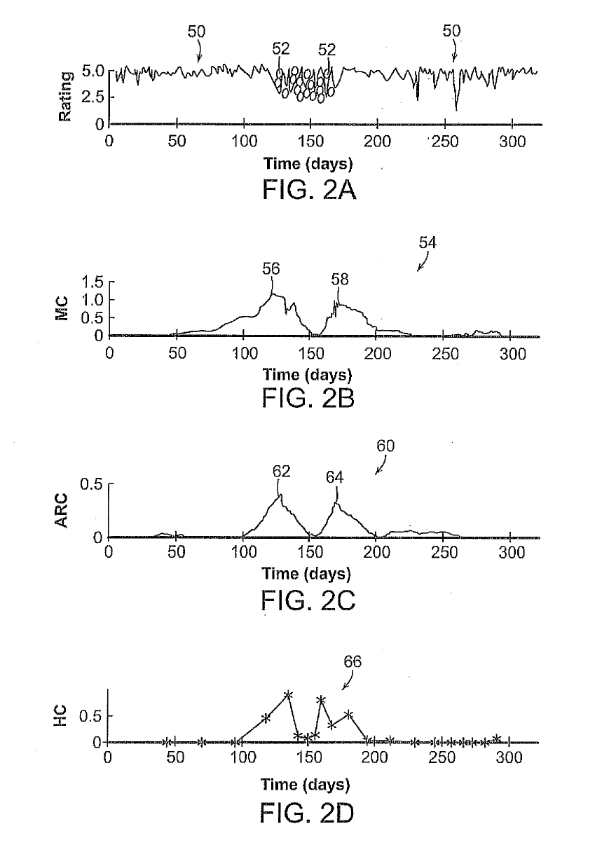

FIGS. 2A-2D show illustrative graphical representations of ratings, a mean change curve, an arrival rate change curve, and a histogram change curve over a period of time in a system in accordance with an embodiment of the invention;

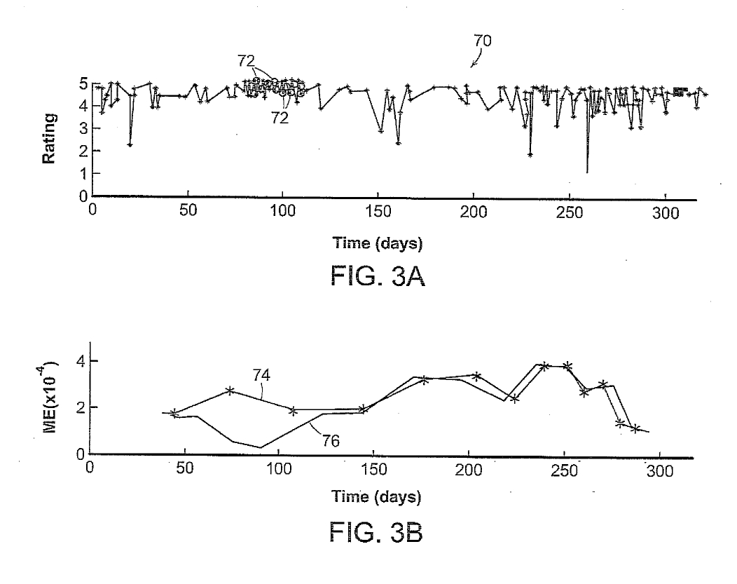

FIG. 3A shows an illustrative graphical representation of ratings over a period of time, and FIG. 3B shows an illustrative graphical representation of model error over the same period of time for the ratings in FIG. 3A;

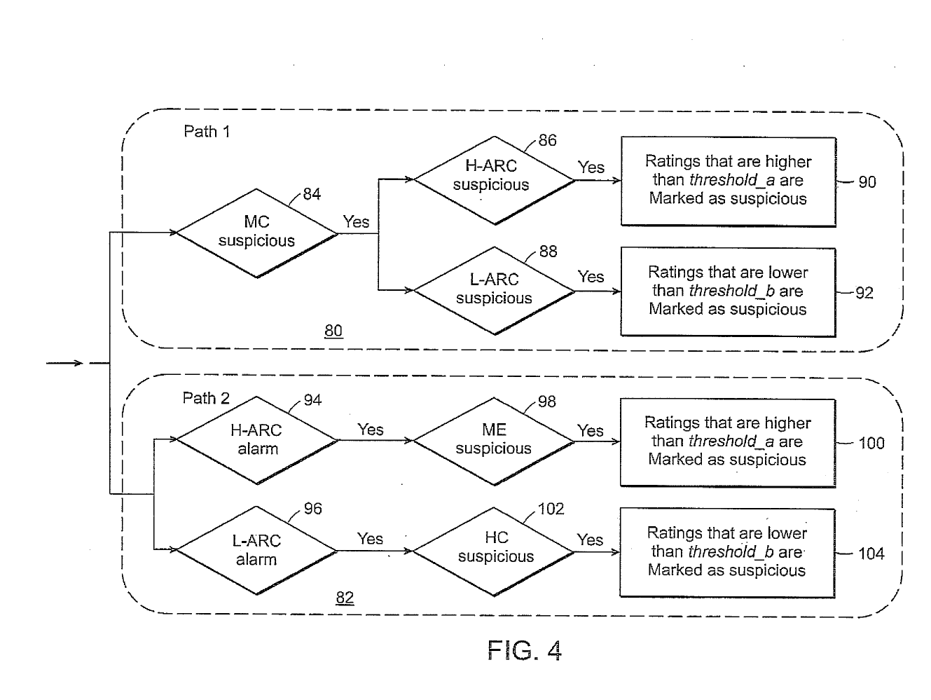

FIG. 4 shows an illustrative functional representation of the operation of detectors in accordance with an embodiment of the invention; and

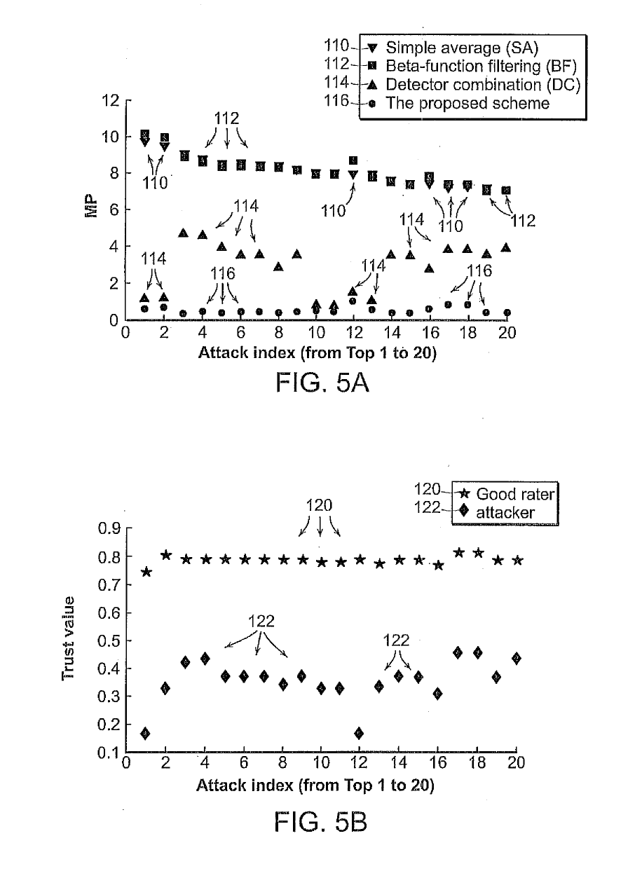

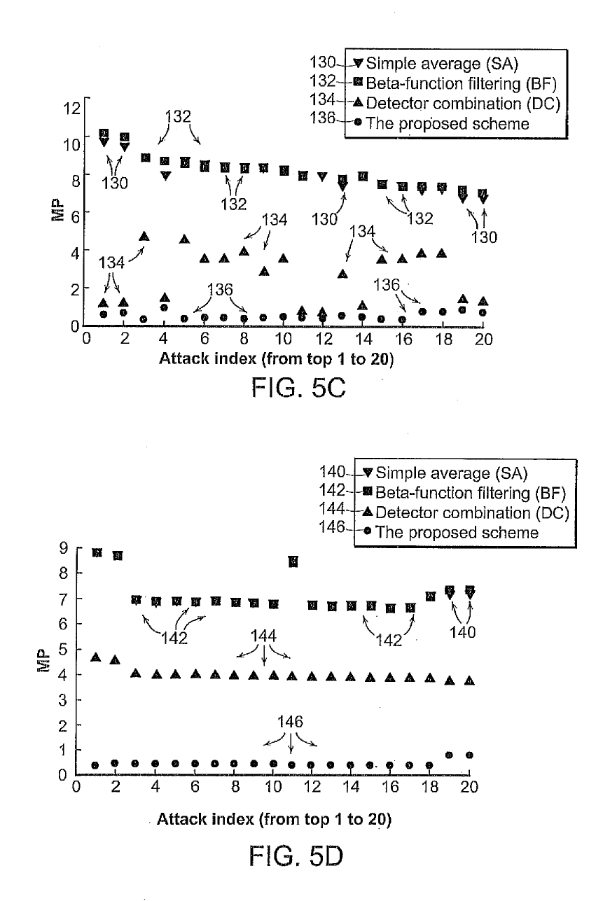

FIGS. 5A-5D show illustrative graphical representations of performance comparisons of systems in accordance with certain embodiments of the invention.

The drawings are shown for illustrative purposes only.

### DETAILED DESCRIPTION

The invention provides a set of procedures that that may be used together to detect smart and collaborative unfair ratings based on signal modeling. Based on the detection, a framework of a trust-assisted rating aggregation system is developed. A procedure called rating challenge is also disclosed to collect unfair rating data from real human users. The proposed system is evaluated through simulations as well as experiments using real attack data. Compared with existing schemes, the proposed system may significantly reduce the impact from collaborative unfair ratings.

Recognizing the limitation of the majority-rule based detection methods, the unfair rating problem is addressed herein from a new approach. Whereas most existing methods treat the rating values as samples of a random variable, the present invention involves, in part, exploiting the time-domain information (i.e., the time when the ratings are provided) and modeling the ratings as a random process.

A suite of novel detectors are developed based on signal modeling. In one detector, honest ratings are treated as noise and unfair ratings are treated as signal. The overall ratings are modeled using an autoregressive (AR) signal modeling technique and examine the model errors. The model error is proved to be a good indicator of whether the signal (i.e., collaborative unfair ratings) is present. Furthermore, hypothesis testing is employed to detect mean change, histogram change, and arrival rate change in the rating process. These detectors are integrated to address a full range of possible ways of inserting unfair ratings.

A trust manager system is also disclosed that is used to evaluate the trustworthiness of raters based on the detection results. The trust information is applied to a trust-assisted rating aggregation algorithm to calculate the final rating scores and to assist future unfair rating detection. To evaluate the proposed methods in the real world, the rating challenge procedure is used to collect attack data from real human users. The methods of various embodiments of the invention disclosed herein, as well as several traditional methods, have been tested against attacks from real human users. Systems of the invention show excellent performance and significantly reduce the impact from unfair ratings.

Systems and methods of the invention may be used to detect collaborative unfair ratings, which is when a group of raters provide unfairly high or low ratings to boost or downgrade the over-all ratings of an object. This type of ratings results from strategic manipulation against online rating systems. It is well known that modeling the human attackers' behavior is very difficult. The rating challenge procedure is used to collect dishonest rating behaviors from real human users. In this challenge, participants inserted unfair ratings into a regular rating data set. The participants who can mislead the final rating scores the most won a cash prize. The proposed scheme and several other schemes were tested against the attack data collected from the rating challenge, instead of against specific attack models.

FIG. 1 shows the overall design of a trustworthy rating aggregation system 10 in accordance with an embodiment of the invention. The system includes a rating aggregator system 12 and a trust manager system 14. The rating aggregator system 12 includes an arrival rate detector 16, a model change detector 18, a histogram detector 20 and a mean change detector 22, each of which receives raw rating data 24. The outputs of each of the detectors 16, 18, 20 and 22 are provided to a suspicious interval detection unit 26, and the outputs of the histogram detector 20 and the mean change detector 22 are also provided to a suspicious rating detection unit 28. The outputs of the suspicious interval detection unit 26 and the suspicious rating detection unit 28 are provided to the trust manager system 14, and the output of the suspicious rating detection unit 28 is also provided to a rating filter 30. The raw rating data 24 is filtered by the rating filter 30 and is processed by a rating aggregation unit 32 prior to being output by the rating aggregator system 12. Both the mean change detector 22 and the rating aggregation unit 32 receive input from the trust manager system 14.

The four detectors 16, 18, 20 and 22 are applied independently to analyze the raw rating data 24. Since the primary goal of the attacker is to boost or reduce the mean value, a mean change detector 22 detects sudden changes in the mean of rating values. When the attackers insert unfair ratings, they may cause an increase in the rating arrival rate. Thus, the arrival rate detector 16 is designed to detect sudden increase in the number of ratings per time unit. A large number of unfair ratings can result in a change in the histogram of overall rating values, especially when the difference between unfair and honest ratings is large. The histogram detector 20 detects such changes in the histogram of the overall rating values. The honest ratings may be viewed as a random noise. In some attacks, the unfair ratings can be viewed as a signal. The signal model change detector 18 is used to detect whether a signal (i.e., unfair ratings) is presented.

The outcomes of above four detectors 16, 18, 20 and 22 are combined to detect the suspicious time intervals by the suspicious interval detection unit 26. Suspicious time intervals are time intervals in which unfair ratings are highly likely. Additionally, the suspicious rating detection unit 28 may mark some specific ratings as suspicious. The trust manager then uses the outcome of suspicious interval detection and suspicious rating detection to determine how much individual raters may be trusted. The rating filter 30 removes highly suspicious ratings, and the rating aggregation unit 32 combines the remaining ratings using trust models.

The trust manager system 14 includes an observation buffer 34 that receives the detection results 27 from the suspicious interval detection unit 26 and receives detection results 29 from the suspicious rating detection unit 28. The output of the observation buffer is provided to a trust calculation unit 36 that in turn is coupled to a trust record unit 38. The trust record unit 38 includes records of individual raters, and communicates with both a malicious rater detection unit 40 and a record maintenance unit 42. The record maintenance unit 42 includes an initialization module 44 and an update according to time module 46. Trust values 48 of the trust record unit 38 are provided to the mean change detector 22 and to the rating aggregation unit 32 of the rating aggregator system 12.

The observation buffer 34 of the trust manager system 14 collects observations on whether specific ratings or time intervals are detected as suspicious. The trust calculation unit 36 together with the trust record 38 compute and store trust values of raters. The malicious rater detection unit 40 determines how to handle raters with low trust values.

As is well known, a trust relationship is always established between two parties for a specific action. That is, one party trusts the other party to perform an action. The first party is referred to as the subject and the second party as the agent. A notation {subject: agent, action} is used to represent the trust relationship. For each trust relationship, one or multiple numerical values, referred to as trust values, describe the level of trustworthiness. In the context of rating aggregation, the rating value provided by the raters is the trust value of {rater: object, having a certain quality}. The trust in raters calculated by the system is the trust value of {system: rater, providing honest rating}. The aggregated rating (i.e., the overall rating score) is the trust value of {system: object, having a certain quality}. When the subject can directly observe the agent's behavior, direct trust can be established.

Trust can also transit through third parties. For example, if A and B have established a recommendation trust relationship and B and C have established a direct trust relationship, then A can trust C to a certain degree if B tells A its trust opinion (i.e., recommendation) about C. Of course, A can receive recommendation about C from multiple parties. This phenomenon is called trust propagation, and indirect trust is established through trust propagations. Procedures for calculating indirect trust are often called trust models. In the context of rating aggregation, the system, the raters, and the object form trust propagation paths. Thus, the aggregated rating, i.e., the indirect trust between the system and the object, can be calculated using trust models. The calculation in rating aggregation can be determined or inspired by existing trust models.

The trust manager determines how much a rater can be trusted based on observations. Obtaining the observations, or in other words extracting features from the raw rating data is however, challenging. A popular trust calculation method is the Beta-function based model proposed in “The beta reputation system” by A. Jøsang and R. Ismail, Proceedings of the 15th Bled Electronic Commerce Conference (June 2002). In this method, trust value is calculated as (S+1)/(S+F+2), where S denotes the number of previous successful actions and F denotes the number of previous failed actions. To examine the trust in rater i, for example, S is the number of honest ratings provided by i, and F is the number of dishonest ratings provided by i. It is, however, impossible to perfectly monitor rater i's past behavior, and S and F values must be estimated through some detection methods.

The mean change detector 22 includes three parts: a mean change hypothesis test, a mean change indicator curve, and a mean change suspiciousness. The mean change hypothesis test involves, letting the value t(n) denote the time for one product when a particular rating is given. The value x(n) denotes the value of the rating, and the value u(n) denotes the IDs of the rater. At time t(j), rater u(j) submits a rating for the product with rating value x(j), where j=1; 2, . . . N and N is the total number of ratings for this product. Assume that a window contains 2 W ratings. Let X₁ denote the first half ratings and X₂ denote the second half ratings in the window. Model X₁ as an i.i.d Gaussian random process with mean A₁ and variance σ², and X2 as an i.i.d Gaussian random process with mean A₂ and variance σ². To detect the mean change, the following hypothesis testing problem is solved:

[symbol]

₀:A₁=A₂

[symbol]

₁:A₁≠A₂

It has been shown in Fundamentals of Statistical Signal Processing by S. Kay, Volume 2: Detection Theory, Prentice Hall (1998) that the Generalized Likelihood Ratio Test (GLRT) for this problem is

Decide [symbol] ₁ (i.e., there is a mean change), if

$$2 ln {L}_{G} ( x ) = \frac{{W ( {\hat{A}}_{1} - {\hat{A}}_{2} )}^{2}}{2 {σ}^{2}} 〉 γ \qquad ( 1 )$$

where Â₁ is the average of X₁ and Â₂ is the average of X₂ and γ is a threshold.

The mean change indicator curve is constructed by the mean change detector 22 using a sliding window with a sliding size (2 W). Based on equation (1) above, the mean change indicator curve is constructed as MC(k) versus t(k), where MC(k) is the value of W(Â₁−Â₂)² calculated for the window containing ratings {x(k−W); . . . ; x(k+W−1)}. In other words, the test in equation (1) above is performed to see whether there is a mean change at the center of the window.

FIG. 2A shows at 50 raw rating data (x(n) vs. t(n)) for a period of time, and shows at 52 unfair ratings that occur during that time. The unfair ratings 52 are shown as small circles in the Figure and are clustered over a relatively short period of time. FIG. 2B shows at 54 the mean change indictor curve for the same time period. The two peaks at 56 and 58 clearly show the beginning and end of the attack.

The mean change suspiciousness is based on the peak values on the mean change indicator curve. The time interval is detected in which abnormal mean change occurs. This interval is the mean change (MC) suspicious interval. When there are only two peaks, the MC suspicious interval is between the two peaks. When there are more than 2 peaks, it is not straightforward to determine which time interval is suspicious, and trust information is therefore used to solve the problem. In particular, all ratings are divided into several segments (e.g., M segments), separated by the peaks on the mean change indicator curve. In each segment, the mean value of ratings are calculated as Bⱼ for j=1; 2; . . . M. The value B_{avg} is the mean value of the overall ratings. A segment j is marked as MC suspicious if either of the following conditions is satisfied:

|Bⱼ−B_{avg}|>thresold₁ 1)

|Bⱼ−B_{avg}|>thresold₂ and Tⱼ/T_{avg} is smaller than a thresold, 2)

where Tⱼ is the average trust value of the raters in the j^{th} segment, and T_{avg} is the average trust value of the raters in all segments. In this example of FIG. 2B, threshold₂<threshold₁. This condition says that there is a moderate mean change and that the raters in the segment are less trustworthy.

The arrival rate detector 16 (shown in FIG. 1) includes four parts: an arrival rate change hypothesis test, an arrival rate change curve, an arrival rate change suspiciousness, and a pair of detectors called the high value ratings arrival rate change (H-ARC detector) and the high value ratings arrival rate change (L-ARC detector).

The arrival rate change hypothesis test is performed as follows. For one product, let y(n) denote the number of ratings received on day n. First consider the arrival rate detection problem inside a window. Assume that the window covers 2D days, starting from day k. In order to detect whether there is an arrival rate change at day k′, for k<k′<k+2D−1, let Y₁=[y(k); y(k+1); . . . y(k0−1)] and Y₂=[y(k′); y(k′+1); . . . ; y(k+2D−1)]. It is assumed that y(n) follow Poisson distribution. The joint distribution of Y₁ and Y₂ is, therefore, provided by:

$$p [ {Y}_{1} , {Y}_{2} ; {λ}_{1} , {λ}_{2} ] = {\prod }_{j = k}^{{k}^{′} - 1} \frac{{e}^{- {λ}_{1}} {λ}_{1}^{y ( j )}}{y ( j ) !} {\prod }_{j = {k}^{′}}^{k + 2 D - 1} \frac{{e}^{- {λ}_{2}} {λ}_{2}^{y ( j )}}{y ( j ) !} \qquad ( 2 )$$

where λ₁ is the arrival rate per day from day k to day k′−1, and λ₂ is the arrival rater per day from day k′ to day k+2D−1. To detect the arrival rate change then requires solving the hypothesis test problem:

[symbol]

₀:A₁=A₂

[symbol]

₁:A₁≠A₂

It may be shown that:

$$p [ {Y}_{1} , {Y}_{2} ; {λ}_{1} , {λ}_{2} ] = \frac{{e}^{- a {λ}_{1}} {λ}_{1}^{a \overline{Y} 1}}{{\prod }_{j = k}^{{k}^{′} - 1} y ( j ) !} \cdot \frac{{e}^{- b {λ}_{2}} {λ}_{2}^{b \overline{Y} 2}}{{\prod }_{j = {k}^{′}}^{k + 2 D - 1} y ( j ) !} \\ where \\ {\overline{Y}}_{1} = \frac{1}{a} {\prod }_{j = k}^{{k}^{′} - 1} y ( j ) \\ and \\ {\overline{Y}}_{2} = \frac{1}{b} {\prod }_{j = {k}^{′}}^{k + 2 D - 1} y ( j ) \qquad ( 3 )$$

and where a=k′−k, and b=k−k′+2D. A generalized likelihood ratio test (GLRT) decides [symbol] ₁ if:

$$\frac{p [ {Y}_{1} , {Y}_{2} ; {\hat{λ}}_{1} , {\hat{λ}}_{2} ]}{[ {Y}_{1} , {Y}_{2} ; \hat{λ} , \hat{λ} ]} > γ \qquad ( 4 )$$

where \hat{λ}₁= Y̅₁, \hat{λ}₂= Y̅₂, and

$$\hat{λ} = \frac{1}{2 D} ( {\sum }_{j = k}^{k + 2 D + 1} y ( j ) ) = \overline{Y}$$

Taking the logarithm at both sides of Equation (4), it is determined that the value [symbol] ₁ may be decided (i.e., there is an arrival rate change) if:

$$\frac{a}{2 D} {\overline{Y}}_{1} ln {\overline{Y}}_{1} + \frac{b}{2 D} {\overline{Y}}_{2} ln {\overline{Y}}_{2} - \overline{Y} ln \overline{Y} \geq \frac{1}{2 D} ln γ \qquad ( 5 )$$

The arrival rate change curve is constructed using Equation (5) as ARC(k′) vs. t(k′). Here, the k′ value is chosen as the center of the sliding window, i.e., k′=k+D. When D<k′<N−D+1, and ARC(k′) is the left-hand side of equation (5) with a=b=D. An example of the ARC curve is shown at 60 in FIG. 2C, with two peaks (62 and 64) showing the beginning and end of the attack.

The arrival rate change suspiciousness is determined based on the peaks on the ARC curve. All ratings are divided into several segments. If the arrival rate in one segment is higher than the arrival rate in the previous segment and the difference between the arrival rates is larger than a threshold, this segment is marked as ARC suspicious.

The H-ARC detector and the L-ARC detector are used in the event that the arrival rate of unfair ratings is not very high or the poison arrival assumption does not hold. For these cases, the H-ARC detector detects the arrival rate change in high value ratings, and the L-ARC detector detects the arrival rate change in low value ratings.

Let yₕ(n) denote the number of ratings that are higher than thresholdₐ received on day n, and yₗ(n) denote the number of ratings that are lower than threshold_{b} received on day n. The thresholdₐ and threshold_{b} are determined based on the mean of all ratings. For the H-ARC detector, replace y(n) in the ARC detector by yₕ(n). For the L-ARC detector, replace y(n) in the ARC detector by yₗ(n). Based on experiments, it has been found that H-ARC and L-ARC are more effective than the ARC detector when the arrival rate of unfair ratings is less than 2 times of the arrival rate of honest ratings.

The histogram change detector 20 of FIG. 1 is employed because unfair ratings may change the histogram of rating data. This detector is based on the clustering technique, and there are two steps involved. First, within a time window k with the center at tₖ, two clusters are constructed from the rating values using the simple linkage method, such as a clusterdata( ) function. Second, the Histogram Change (HC) curve, HC(k) versus tₖ is calculated as

$$HC ( k ) = min ( \frac{{n}_{1}}{{n}_{2}} , \frac{{n}_{2}}{{n}_{1}} ) \qquad ( 6 )$$

where n₁ and n₂ denote the number of ratings in the first and the second cluster, respectively. The example of the HC curve is shown at 66 in FIG. 2. When the attack occurs, the HC(k) increases.

The model change detector 18 of FIG. 1 functions as follows. Let E(x(n)) denote the mean of x(n), where x(n) denote rating values. When there is no collaborative raters, ratings received at different time (also from different raters) should be independent. Thus, (x(n)−E(x(n))) should approximately be a white noise. When there are collaborative raters, (x(n)−E(x(n))) is not white noise any more. Instead, the ratings from collaborative raters can be looked at as a signal embedded in the white noise. Based on the above argument, we develop an unfair rating detector through signal modeling.

Model error (ME) based detection is performed as follows. The ratings in a time window are fit onto an autoregressive (AR) signal model. The model error is examined. When the model error is high, x(n) is close to a white noise, i.e., honest ratings. When the model error is small, there is a signal presented in x(n) and the probability that there are collaborative raters is high. The model error (ME) curve is constructed with the vertical axis as the model error, and horizontal axis as the center time of the windows. The windows are constructed either by making them contain the same number of ratings or have the same time duration. The covariance method disclosed Statistical Digital Signal Processing and Modeling by M. Hayes, John Wiley and Sons (1996). is used to calculate the AR model coefficients and errors.

FIG. 3A shows at 70 original ratings over a period of time, and shows at 72 (in small circles) unfair ratings that have an attack duration of about 30 days with a bias of 0.1, a variance of 0.1× variance of honest ratings, and an arrival rate of 2× arrival rate of honest ratings. The example of an ME curve is shown in FIG. 3. The curve 74 (marked with an asterisks) is the model error for the original rating data, and the curve 76 marked is the model error when unfair ratings are present. It may be seen that the model error drops when there is an attack. The time interval when the model error drops below a certain threshold is marked as the model error (ME) suspicious interval.

The attacking behaviors may be very complicated. Several detection strategies must be used simultaneously. A further challenge is to understand the effectiveness of each detector against different attacks and to integrate multiple detectors such that a broad range of attacks may be handled.

The arrival rate detector 16, the model change detector 18, the histogram detector 20 and the mean change detector 22 all function in parallel to provide comprehensive protection since attack behaviors are very diverse and cannot be described by a single model. Different attacks have different features. For example, one attack may trigger mean change (MC) and H-ARC detectors, another attack may trigger only L-ARC and histogram change (HC) detectors. In addition, the normal behaviors, i.e., honest ratings, are not stationary. Even without unfair ratings, honest ratings can have variation in mean, arrival rate, and histogram. In smart attacks, the changes caused by unfair ratings and the normal changes in honest ratings are sometimes difficult to differentiate. Thus, using a single detector will cause a high false alarm rate. Experiments have been conducted and the results from these detectors have been compared quantitatively based on their Receiver Operating Characteristics (ROC) curves. Based on ROC analysis and a study of real user attacking behavior, an empirical method has been developed to combine the proposed detectors, as illustrated in FIG. 4.

As shown in FIG. 4, there are two detection paths 80 and 82. Path 1, shown at 80, is used to detect strong attacks. If the MC indicator curve has a U-shape (step 84), and H-ARC indicator curve (step 86) or the L-ARC indicator curve (step 88) also has a U-shape, then the corresponding high or low ratings inside the U-shape will be marked as suspicious. In particular, if the MC indicator curve has a U-shape (step 84), and H-ARC indicator curve (step 86) also has a U-shape, then the ratings that are higher than threshold, are marked as suspicious (step 90). If the MC indicator curve has a U-shape (step 84), and L-ARC indicator curve (step 88) also has a U-shape, then the ratings that are lower than threshold_{b} are marked as suspicious (step 92).

If for some reasons, the H-ARC (or L-ARC) indicator curve does not have such a U-shape, then the H-ARC alarm (step 94), or the L-ARC alarm (step 96) is issued. The alarm will be followed by the ME or HC detector. This is path 2 as shown at 82, which detects suspicious intervals. If the H-ARC alarm is set and the ME is suspicious (step 98), then the ratings that are higher than thresholdₐ are marked as suspicious (step 100). If the L-ARC alarm is set and the HC is suspicious (step 102), then the ratings that are lower than threshold_{b} are marked as suspicious (step 104). Since there may be multiple attacks against one product, the ratings must go through both paths.

As it is not possible to perfectly differentiate unfair ratings and honest ratings in the suspicious intervals, some honest ratings will be marked as suspicious. As a consequence, it is not appropriate to simply filter out all suspicious ratings. This suspicious rating information is instead used in the above systems to calculate trust in raters, based on the beta-function trust model. This calculation is performed as follows. First, for each rater i, initialize Sᵢ=0 and Fᵢ=0. For k=1 to K, do the following. Let \hat{t}(k) denote the time when trust in raters is calculated, and k is the index. For each rater i, set nᵢ=fᵢ=0, then considering all products being rated during time \hat{t}(k−1) and \hat{t}(k), determine nᵢ (which is the number of ratings that are provided by rater i), and determine fᵢ (which is the number of ratings from rater i that are marked as suspicious). The calculate Fᵢ=Fᵢ+fᵢ and Sᵢ=Sᵢ+nᵢ−fᵢ. Then calculate the trust in the rater I at time \hat{t}(k) as (Sᵢ+1)/(sᵢ+Fᵢ+2). Repeat these steps for each rater i.

Several trust models, including simple average and complicated ones, have been compared for rating aggregation based on the techniques disclosed in “Building trust in online rating systems through signal modeling” by Y. Yang, Y. Sun, Y. Ren and Q. Yang, Proceedings of IEEE ICDCS Workshop on Trust and Reputation Management (2007), the disclosure of which is hereby incorporated by reference, a modified weighted average trust model was developed to combine rating values from different raters.

Let R denote the set of raters whose ratings are the inputs to the aggregation module. If rater iεR, let rᵢ denote the rating from rater i and Tᵢ denote the current trust value of rater i. In addition, each rater provides only one rating for one object and R_{ag} denotes the aggregated rating. Then R_{ag} is as follows,

$${R}_{ag} = \frac{1}{{\sum }_{i : i ∈ R} max ( {T}_{i} - 0.5 , 0 )} {\sum }_{i : i ∈ R} {r}_{i} max ( {T}_{i} - 0.5 , 0 )$$

For any online rating systems, it is very difficult to evaluate the attack-resistance properties in practical settings due to the lack of realistic unfair rating data. Even if one can obtain data with unfair ratings from e-commerce companies, there is no ground truth about which ratings are dishonest. To understand human users' attacking behavior and evaluate the proposed scheme against non-simulated attacks, a Rating Challenge routine was employed. In this challenge, real online rating data was collected for 9 flat panel televisions with similar features. The data are from a well-known online-shopping website. The numbers of fair ratings of the nine products are 177, 102, 238, 201, 82, 87, 60, 53, and 97.

The participants to the Rating Challenge download the rating dataset and control 50 biased raters to insert unfair ratings. In particular, the participants decide when the 50 raters rate, which products they rate for, and the rating values. The participants' goal was to boost the ratings of two products and reduce the ratings of two other products. The participants' attacks were judged by the overall manipulation power, called MP value. For each product, the value Δᵢ was calculated where Δᵢ=|R_{ag}(tᵢ)−R_{ag}⁰(tᵢ)| during every 30 day period, where R_{ag}(tᵢ) is the aggregated rating value with unfair ratings, and R_{ag}⁰(tᵢ) is the aggregated rating value without unfair ratings. The overall MP value was calculated as

$${\sum }_{k} ( {Δ}_{{max}_{1}}^{k} + {Δ}_{{max}_{2}}^{k} )$$

where Δₘₐₓ_{₁}^{k} and Δₘₐₓ_{₂}^{k} are the largest and 2^{nd} largest among {Δᵢ}'s for product k. The participant that generated the largest MP value was the winner.

In the calculation of the MP values, the two big-deltas represent 2 to 3 months of persistent change in rating scores. The calculation also considers both boosting and downgrading. In total, 251 valid submissions were calculated, which correspond to 1004s set of collaborative unfair ratings for single products. Three observations were made. First, more than half of the submitted attacks were straightforward and did not exploit the features of the underlying defense mechanisms. Many attacks spread unfair ratings over the entire rating time. Second, among the attacks that exploited the underlying defense mechanisms, many were complicated and previously unknown. Third, according to a survey after the challenge, many successful participants generated unfair ratings manually. This data set covers a broad range of attack possibilities.

In the performance evaluation, all raters' trust values were assigned as 0.5 initially. The window size of the MC detector, H-ARC/L-ARC detectors, HC detector, and ME detector were 30 (days), 30 (days), 40 (ratings), and 40 (ratings), respectively. In the H-ARC and L-ARC detectors, thresholdₐ=0:5 m and threshold_{b}=0:5 m+0:5, where m is the mean of the ratings in the time window. For the purposed of comparison, the performances of three other schemes were evaluated.

Scheme one (SA Scheme, no attack detection) involved using simple averaging for rating aggregation. Scheme two (BF Scheme) involved using the beta-function based filtering technique discussed above to remove unfair ratings. The trust value of rater i was then calculated as (Si+1)=(Si+Fi+2), where Fi is the number of ratings (from rater i) that have been removed, and Fi+Si is the total number of ratings provided by rater i. The third scheme (DC scheme) involved using the proposed detectors without trust establishment.

The performance comparisons among different schemes under the strongest attacks collected from the rating challenge were as follows. In Experiment 1, the top 20 attacks against the SA Scheme were chosen. That is, these 20 attacks generated the highest MP values when the SA scheme was used. FIG. 5A shows a comparison of the results of the four schemes under these 20 attacks. The horizontal axis of each is the index of the attack data set from top 1 to top 20. The vertical axis of each is the overall MP value, which is the summation of individual products' MP values in each submission. The MP values for the simpler average (SA) are shown at 110, the MP values for the Beta-function filtering (BF) are shown at 112, the MP values for the detector combination (DC) are shown at 114, and the MP values for the processes proposed herein are shown at 116.

Three observations are in order. First, it is clear that the proposed scheme has the best performance. It can significantly reduce the MP values resulting from real users' attacks. Second, the performance of the SA scheme is similar to that of BF scheme. The BF method is even slightly worse than the SA in some situations, and there are two reasons for this. When the unfair ratings are concentrated in a short time interval, the majority ratings in this time interval can be unfair ratings. Using the majority rule, the beta filter will in fact remove good ratings. This is why the beta filter performs worse. Moreover, when the attacks do not have a large bias, the beta filter cannot detect unfair ratings. This is why the beta filter has almost the same performance as the simple averaging under some attacks. The beta filter scheme therefore, as well as other majority-rule based schemes, is not effective in detecting smart attacks from real human users.

Third, trust establishment plays an important role in the proposed scheme. Although the proposed detectors without trust models can reduce MP value greatly, the performance is still worse than that of the proposed scheme with trust. No matter how good the detectors are, there is a small amount of false alarm. With trust establishment, good users and bad users can be distinguished in several rounds rather than in one shot. FIG. 5B, shows the trust values of the honest raters and the trust values of the raters inserted by the attackers. In particular, the trust values of good raters are shown at 120 and the trust values of the attackers are shown at 122. Trust values of good raters are much higher than that of unfair raters. This partially explains the good performance of the proposed scheme.

In Experiment 2, the top 20 attacks that were strongest against the BF scheme were selected. FIG. 5C shows the performances of the four schemes. The MP values for the simpler average (SA) are shown at 130, the MP values for the Beta-function filtering (BF) are shown at 132, the MP values for the detector combination (DC) are shown at 134, and the MP values for the processes proposed herein are shown at 136. Again, the proposed scheme has the best performance; SA and BF have similar performance; DC can catch most of the unfair ratings but its performance is worse than the proposed scheme with trust.

In Experiment 3, 20 attacks were selected that were strongest against the DC scheme. As shown in FIG. 5D, The MP values for the simpler average (SA) are shown at 140, the MP values for the Beta-function filtering (BF) are shown at 142, the MP values for the detector combination (DC) are shown at 144, and the MP values for the processes proposed herein are shown at 146. The DC still performs much better than SA and BF. There is a significant gap between DC and the proposed scheme, which represents the performance advantage resulting from trust establishment.

In Experiment 4, the minimum, maximum and average MP values of each method were evaluated when they were facing the 20 strongest attacks against them. The advantages of the proposed scheme are clearly shown in Table 1, a copy of which is reproduced below. Compared with the majority-rule based methods and simple averaging, the proposed scheme reduces the MP value by a factor of 3 or more.

TABLE 1

| Manipulation power | MP Min | MP Max | MP Average |
|---|---|---|---|
| Simple average | 7.12 | 9.79 | 8.10 |
| Beta-function filtering | 7.15 | 10.18 | 8.14 |
| Detector combination | 3.75 | 4.63 | 3.96 |
| The proposed scheme | 1.83 | 2.73 | 2.11 |

When deriving the detectors, it was assumed that colluded profit-driven unfair ratings might have patterns that are somehow different from regular ratings. In the evaluation process, this assumption was not made. Instead, all of the unfair ratings were provided by real human users. In addition, the Poisson arrival assumption was only used to simplify the derivation of the ARC detector, and was not used in performance evaluation. Finally, the ARC detectors only detect rapid changes, and were not triggered by slow variations in arrival rate. Similarly, the mean change detector was triggered only by rapid mean change, and did not require constant mean in honest ratings.

Trust establishment is primarily for reducing the false alarm rate of the detectors. Even if some honest ratings are wrongly marked as suspicious by the proposed detectors for some reason, the proposed trust establishment mechanism will correct this false alarm after more observations are made.

The problem of detecting and handling unfair ratings in on-line rating systems is addressed herein. In particular, a comprehensive system for integrating trust into rating aggregation process is proposed. For detecting unfair ratings, we developed a model error based detector, two arrival rate change detectors, a histogram change detector, and adopted a mean change detector. These detectors cover different types of attacks. A method for jointly utilizing these detectors is developed. The proposed solution can detect dishonest raters who collaboratively manipulate rating systems. This type of unfair raters is difficult to be caught by the existing approaches. The proposed solution can also handle a variety of attacks. The proposed system is evaluated against attacks created by real human users and compared with majority-rule based approaches. Significant performance advantage is observed.

Those skilled in the art will appreciate that numerous modifications and variations may be made to the above disclosed embodiments without departing from the spirit and scope of the invention.

What is claimed is:

1. A method of detecting unfair ratings in rating data over a period of time in connection with an on-line rating system, said method comprising the steps of:
detecting changes in an arrival rate of ratings in the rating data over the period of time and providing arrival rate change data;
detecting changes in a model of the rating data over the period of time such that changes in the model are represented as model errors and providing model error data;
detecting changes in a histogram of the rating data over the period of time and providing histogram detection data;
detecting changes in a mean of the rating data over the period of time and providing mean change detection data; and
processing the arrival rate change data, the model error data, the histogram detection data, and the mean change detection data to identify unfair ratings in the rating data.

2. The method as claimed in claim 1, wherein said step of processing the arrival rate change data, the model error data, the histogram detection data, and the mean change detection data to identify unfair ratings in the rating data, involves developing a trust analysis of each rating providing the rating data over the period of time.

3. The method as claimed in claim 1, wherein said model error data represents unfair ratings as a signal and represents fair ratings as noise.

4. The method as claimed in claim 3, wherein said step of detecting changes in a model of the rating data over the period of time involves determining identifying a period of time as suspicious when the model error falls below a defined model error threshold.

5. The method as claimed in claim 1, wherein said step of processing the rate change data, the model error data, the histogram detection data, and the mean change detection data to identify unfair ratings in the rating data involves providing each of the rate change data, the model error data, the histogram detection data, and the mean change detection data to a suspicious interval detection unit that identifies an time intervals within the period of time as being suspicious.

6. The method as claimed in claim 1, wherein said method further includes the step of filtering the raw data to remove the unfair ratings.

7. The method as claimed in claim 1, wherein said step of detecting changes in an arrival rate of ratings in the rating data over the period of time involves detecting both high-value rating arrival rate changes within the period of time as well as low-value rating arrival rate changes within the period of time.

8. The method as claimed in claim 1, wherein said step of detecting changes in a histogram of the rating data over the period of time involves the steps of dividing at least a portion of the period of time into a plurality of clusters, and identifying a histogram change in each of the plurality of clusters.

9. The method as claimed in claim 1, wherein said step of detecting changes in a mean of the rating data over the period of time involves detecting a mean change within a plurality of fixed windows of time within the period of time.

10. The method as claimed in claim 9, wherein said step of detecting changes in a mean of the rating data over the period of time further involves detecting a mean change within a sliding window of time within the period of time.

11. The method as claimed in claim 1, wherein said step of detecting changes in a mean of the rating data over the period of time involves receiving trust values from a trust manager system.

12. The method of detecting unfair ratings in rating data over a period of time in connection with an on-line rating system, said method comprising the steps of:
detecting changes in a model of the rating data over the period of time such that changes in the model are represented as model errors and providing model error data;
detecting changes in a histogram of the rating data over the period of time and providing histogram detection data;
detecting changes in a mean of the rating data over the period of time and providing mean change detection data;
providing the detection results based on the model error data, the histogram detection data and the mean change data to a trust management system, which provides trust values for each of a plurality of raters; and
processing the trust values for each of a plurality of raters to identify unfair ratings in the rating data.

13. The method as claimed in claim 12, wherein said model error data represents unfair ratings as a signal and represents fair ratings as noise.

14. The method as claimed in claim 13, wherein said step of detecting changes in a model of the rating data over the period of time involves determining identifying a period of time as suspicious when the model error falls below a defined model error threshold.

15. The method as claimed in claim 12, wherein said step of detecting changes in a histogram of the rating data over the period of time involves the steps of dividing at least a portion of the period of time into a plurality of clusters, and identifying a histogram change in each of the plurality of clusters.

16. The method as claimed in claim 12, wherein method further includes the step of detecting changes in an arrival rate of ratings in the rating data over the period of time and providing arrival rate change data;

17. The method as claimed in claim 12, wherein said method further includes the step of combining ratings using trust values from the trust management system.

18. A system for detecting unfair ratings in rating data over a period of time for in connection with an on-line rating system, said system comprising:
arrival rate change detection means for detecting changes in an arrival rate of ratings in the rating data over the period of time and providing arrival rate change data;
model change detection means for detecting changes in a model of the rating data over the period of time such that changes in the model are represented as model errors and providing model error data;
histogram detection means for detecting changes in a histogram of the rating data over the period of time and providing histogram detection data;
mean change detection means detecting changes in a mean of the rating data over the period of time and providing mean change detection data;
a trust manager system for receiving the arrival rate change data, the model error data, the histogram detection data, and the mean change detection data, and for providing trust values for each of a plurality of raters; and
filter means for removing unfair ratings based on the trust values.

19. The system as claimed in claim 18, wherein said model error data represents unfair ratings as a signal and represents fair ratings as noise.

20. The method as claimed in claim 18, wherein the model change detection means identifies a period of time as suspicious when the model error falls below a defined model error threshold.
